(19) United States
(12) Patent Application Publication
(10) Pub. No.: US 2011/0229750 A1
(43) Pub. Date: Sep. 22, 2011

(54) Polyolefin Fibers for Use as Battery Separators and Methods of Making and Using the Same

(75) Inventors: Joseph M. McLellan, Quincy, MA (US); Xinhua Li, Newton, MA (US); Shih-Chi Chen, Cambridge, MA (US); David Picard, Jamaica Plains, MA (US)

(73) Assignee: Nano Terra Inc., Cambridge, MA (US)

(21) Appl. No.: 12/886,082

(22) Filed: Sep. 20, 2010

Related U.S. Application Data
(60) Provisional application No. 61/243,917, filed on Sep. 18, 2009.

(51) Int. Cl. H01M 2/16; D04H 3/16; B29C 47/12

(52) U.S. Cl. 429/144; 264/115; 425/464

(57) ABSTRACT

The present invention is directed to battery separators comprising layers of non-woven, melt-blown polyolefin fibers, and methods of making and using the same.

### CROSS-REFERENCE TO RELATED APPLICATIONS

This application claims the benefit of the filing date of U.S. Provisional Appl. No. 61/243,917, filed Sep. 18, 2009, which is incorporated herein by reference in its entirety.

### BACKGROUND OF THE INVENTION

1. Field of the Invention

The present invention is directed to melt-blown polyolefin compositions suitable for use as battery separators, methods for making the compositions, and products prepared using the compositions.

2. Background

Storage batteries include a plurality of alternating positive and negative electrodes. Separators comprising a porous material are placed between the alternating electrodes to prevent electrical contact. The separators allow an electrolyte, such as an acid, and ions to pass between the plates.

The battery separators must be resistant to oxidative degradation and unreactive under strongly acidic conditions at ambient and elevated temperatures. The battery separators should also allow a high degree of ionic movement and/or have a low electrical resistance. The battery separators should also be capable of inhibiting the formation of conductive paths between plates, which can arise during battery operation when parts of the battery electrode become dispersed in the electrolyte and precipitate or become deposited in the separator.

In flooded cell lead acid batteries, the separators are not highly porous, do not absorb significant amounts of acid, and typically have a fixed thickness. The separators serve primarily to prevent migration of particles and typically include ribs that physically separate the electrodes.

Sealed- or valve-regulated lead acid batteries can include a reservoir of electrolyte that is completely contained or absorbed by the separators, and the separators fill the space between the electrodes and contact the electrodes. Such battery separators must have a free volume that permits transport of oxygen gas generated at the positive electrodes, during charging or overcharging, to the negative electrodes where the gas is reduced (e.g., to form lead oxide, which is converted to lead sulfate and free water). Suitable materials that have been previously used as separators in such batteries include borosilicate glass microfiber mats having a small pore size and large free volume that enables the mat to readily absorb and stably retain an electrolyte.

However, separators containing sub-micron glass fibers have several disadvantages including environmental health and safety concerns (e.g., a tendency to release airborne particles), poor mechanical properties, and a large weight.

Early proposals to use melt-blown polymeric fiber mats to make battery separators included the addition of internal and/or external surfactants to render the fiber mats wettable. See, e.g., U.S. Pat. Nos. 3,847,676, 3,918,995, 3,933,525, 3,972,759, 4,000,967, 4,110,143, 4,146,686, 4,165,351, 4,251,605, 4,501,793, 4,529,677, 5,641,565 and 6,120,939. However, such mats have disadvantages arising from low porosity, large and/or non-uniform pore size, and limited wettability.

### BRIEF SUMMARY OF THE INVENTION

What is needed is a polymeric composition that is readily wettable by an aqueous solution and stable under a wide range of operating conditions.

The present invention is directed to an extruder die comprising a base portion having a cavity therein, and a tip portion having a plurality of holes there through, the holes fluidly connecting the cavity with a plurality of openings in the tip, wherein the holes and openings have a diameter of 250 μm or less.

The present invention is also directed to a battery separator comprising a layer of non-woven, melt-blown polyolefin fibers that include a hydrophilic polymer covalently attached to an outer surface of the fibers, wherein the hydrophilic polymer is selected from the group consisting of: polyethyleneimine, a block copolymer of ethylene and acrylic acid; a block copolymer of ethylene and ethylene oxide; a triblock copolymer of ethylene oxide and propylene oxide; a poly(perfluoropropylene glycol) carboxylate; a block copolymer of a perfluoropolyether and polyethylene glycol; a copolymer of styrene and ethylene oxide; a copolymer of methacrylic acid and acrylic acid; a polysiloxane having alkyl and ethylene oxide side groups; a polyvinylamine having alkyl and ethylene oxide side groups; a polyvinylpyridine; a polyvinylsulfonate; a polyvinylphosphate; a polyvinylpyrrolidone; a polystyrenesulfonate; a polyvinylalcohol; a polyvinylacetate; and combinations thereof.

The present invention is also directed to a battery separator comprising a layer of non-woven, melt-blown polyolefin fibers that include a conformal metal oxide layer coating the fibers.

In some embodiments, the metal oxide is selected from the group consisting of: silica, titania, alumina, zirconia, boron oxide, germania, and combinations thereof. In some embodiments, the conformal metal oxide layer has a thickness of 2 nm to 500 nm.

In some embodiments, a batter separator comprises outer layers of the non-woven, melt-blown polyolefin fibers having a mean diameter of 50 nm to 1 μm, and an inner layer comprising non-woven, melt-blown polyolefin fibers having a mean diameter of 1 μm to 20 μm.

In some embodiments, the non-woven, melt-blown polyolefin fibers include an amphiphilic species in a concentration of 0.1% to 20% by weight, wherein the amphiphilic species has an average molecular weight less than 10,000 Da, includes a hydrophilic functional group, is substantially insoluble in water, and renders the non-woven, melt-blown polyolefin fibers wettable by an aqueous solution at room temperature.

The present invention is also directed to a battery separator comprising outer layers comprising non-woven, melt-blown polyolefin fibers having a mean diameter of 50 nm to 1 μm, and an inner layer comprising non-woven, melt-blown polyolefin fibers having a mean diameter of 1 μm to 20 μm, wherein the non-woven, melt-blown polyolefin fibers include an amphiphilic species in a concentration of 0.1% to 20% by weight, and wherein the amphiphilic species has an average molecular weight less than 10,000 Da, includes a hydrophilic functional group, is substantially insoluble in water, and renders the non-woven, melt-blown polyolefin fibers wettable by an aqueous solution at room temperature.

In some embodiments, the outer layers have a fabric weight of 10 g/m² to 100 g/m², and the inner layer has a fabric weight of 100 g/m² to 500 g/m².

In some embodiments, the amphiphilic species comprises a first component having an average molecular weight of 500 Da or less and a second component having an average molecular weight of 500 Da to 5,000 Da.

In some embodiments, the first component has a structure selected from: a polyethylene or polypropylene portion of 4 to 20 units with a hydrophilic, non-ionic head group; a polyethylene or polypropylene portion of 4 to 20 units linked to a hydrophilic, ionic head group; a polyethylene glycol portion of 1 to 10 units linked to a hydrophobic head group; a block copolymer of ethylene and ethylene oxide; a block copolymer of a perfluoropolyethylene or perfluoropolypropylene and a polyethylene glycol; and combinations thereof.

In some embodiments, the second component is a triblock copolymer of ethylene oxide and propylene oxide.

In some embodiments, the amphiphilic species comprises IRGASURF® SR 100, IRGASURF®HL 560, or a similar species.

In some embodiments, the battery separator has a porosity of 60% to 98% by volume in a compressed state. In some embodiments, the battery separator has a surface area of 5 m²/g or greater.

In some embodiments, the polyolefin fiber is selected from the group consisting of: polyethylene, polypropylene, polystyrene, polyvinylchloride, and combinations thereof.

The present invention is also directed to a valve-regulated lead acid battery comprising a battery separator described herein, wherein the valve-regulated lead acid battery has a prismatic or a spiral-wound configuration. When used in a battery separator, the melt-blown fiber compositions can wick and absorb an acid electrolyte to completely fill the space between electrodes.

The present invention is also directed to a method of making a battery separator, the method comprising:

melt-blowing a first layer of polyolefin fibers having an average diameter of 50 nm to 1 μm;

melt-blowing a second layer of polyolefin fibers onto the first layer, wherein the polyolefin fibers of the second layer have an average diameter of 1 μm to 20 μm; and

melt-blowing a third layer of polyolefin fibers onto the second layer to provide the battery separator, wherein the polyolefin fibers of the third layer have an average diameter of 50 nm to 1 μm, wherein the melt-blown polyolefin fibers in the first, second, and third layers include an amphiphilic species, and wherein the amphiphilic species has an average molecular weight less than 10,000 Da, includes a hydrophilic functional group, is substantially insoluble in water, and renders the non-woven, melt-blown polyolefin fibers wettable by an aqueous solution at room temperature.

In some embodiments, the method comprises coating the battery separator with a conformal metal oxide layer.

In some embodiments, said coating comprises contacting the battery separator with a solution comprising: an acid and a metal oxide precursor selected from the group consisting of: a metal alkoxide, a metal hydroxide, an alkoxy-metal hydroxide, an alkoxy-metal hydride, and combinations thereof.

In some embodiments, the method comprises functionalizing the polyolefin fibers with a linker group, and covalently attaching a hydrophilic polymer to a surface of the polyolefin fibers through the linker group.

In some embodiments, the linker group is selected from the group consisting of: epichlorohydrin, a silane, a vinyl, a hydroxy, a carboxylic acid, and combinations thereof.

In some embodiments, the hydrophilic polymer is selected from the group consisting of: polyethyleneimine, a block copolymer of ethylene and acrylic acid; a block copolymer of ethylene and ethylene oxide; a triblock copolymer of ethylene oxide and propylene oxide; a poly(perfluoropropylene glycol) carboxylate; a block copolymer of a perfluoropolyether and polyethylene glycol; a copolymer of styrene and ethylene oxide; a copolymer of methacrylic acid and acrylic acid; a polysiloxane having alkyl and ethylene oxide side groups; a polyvinylamine having alkyl and ethylene oxide side groups; a polyvinylpyridine; a polyvinylsulfonate; a polyvinylphosphate; a polyvinylpyrrolidone; a polystyrenesulfonate; a polyvinylalcohol; a polyvinylacetate; and combinations thereof.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 provides a top- or side-view schematic representation of a battery separator of the present invention.

FIGS. 2A and 2B provide a cross-sectional schematic representation of an extruder die of the present invention.

FIG. 3 provides a three-dimensional cross-sectional schematic representation of an extruder die of the present invention.

FIG. 4 provides a side-view schematic representation of an extruder die of the present invention.

FIGS. 5 and 6 provide three-dimensional graphic representations of mechanical stress and deformation in an extruder die of the present invention under an external pressure applied to the backside of the extruder die.

FIGS. 7A-7B provide graphic representations of the compressibility of polyolefin fiber mats of the present invention compared with absorptive glass mats.

FIG. 8 provides an image of an electrochemical test cell for testing the battery separators of the present invention.

One or more embodiments of the present invention will now be described with reference to the accompanying drawing. In the drawing, like reference numbers can indicate identical or functionally similar elements.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

References to spatial descriptions (e.g., “above,” “below,” “up,” “down,” “top,” “bottom,” etc.) made herein are for purposes of description and illustration only, and should be interpreted as non-limiting upon the melt-blown battery separators, methods, and products of any method of the present invention, which can be spatially arranged in any orientation or manner.

### Melt-Blown Polyolefin Compositions and Methods of Making

The melt-blown fiber compositions are formed using a melt-blowing apparatus. The apparatus includes a pressurized, heated extruder die through which a plurality of filaments of molten thermoplastic polyolefins are extruded. The extruder die also uses heated and pressurized air flowing in the direction of extrusion to attenuate the molten polyolefin upon exit from the orifices. The fibers are continuously deposited on a moving conveyor to form a consolidated flat web of desired thickness, which may be cut into the desired shape. In some embodiments, the melt-blown polyolefin fiber compositions can be prepared using conventional means, and the design and operation are well within the ability of those skilled in the art. For example, suitable apparatus and methods are described in U.S. Pat. Nos. 3,849,241 and 3,972,759, which are incorporated herein by reference in their entirety.

Generally, the process can be varied according to the values in the following Table.

TABLE
Process parameters for preparing melt-
blown layers of polyolefin fibers.

| Parameter | Value |
|---|---|
| Ambient Air Temperature | 100° C.-400° C. |
| Extruder Die Zone 2 Temperature | 100° C.-400° C. |
| Extruder Die Zone 3 Temperature | 100° C.-400° C. |
| Extruder Die Zone 4 Temperature | 100° C.-400° C. |
| Air Temperature at Die | 200° C.-400° C. |
| Extruder Current | 1 amps-10 amps |
| Hole Size | 0.002 in-0.015 in. |
| Collector Speed | 0.5 m/min-20 m/min |
| Air Pressure | 5 psi-50 psi |
| Extruder Die Pressure | <200 psi |
| Extruder Die-to-Collector Distance | 100 mm-1,000 mm |
| Throughput | 0.1 g/hole/min-1 g/hole/min |

From these considerations, a person skilled in the art will be able to prepare a melt-blown layer of polyolefin fibers having a uniform thickness. In general, fibers present in a battery separator have an mean diameter of 50 nm to 20 μm. The average fiber diameter can be selected based on equipment used for the extruding and process conditions. In some embodiments, as the diameter of the holes in the extruder die is decreased, the fiber diameter will also be decreased. Not being bound by any particular theory, uniformity of the fibers can be maintained by using a monodisperse polyolefin precursor, a substantially homogeneous melt mixture, a uniform pressure profile of the melt mixture on the backside of the extruder die, and having a uniform air pressure and air flow profile surrounding the extruder die and the laminar zone away from the die.

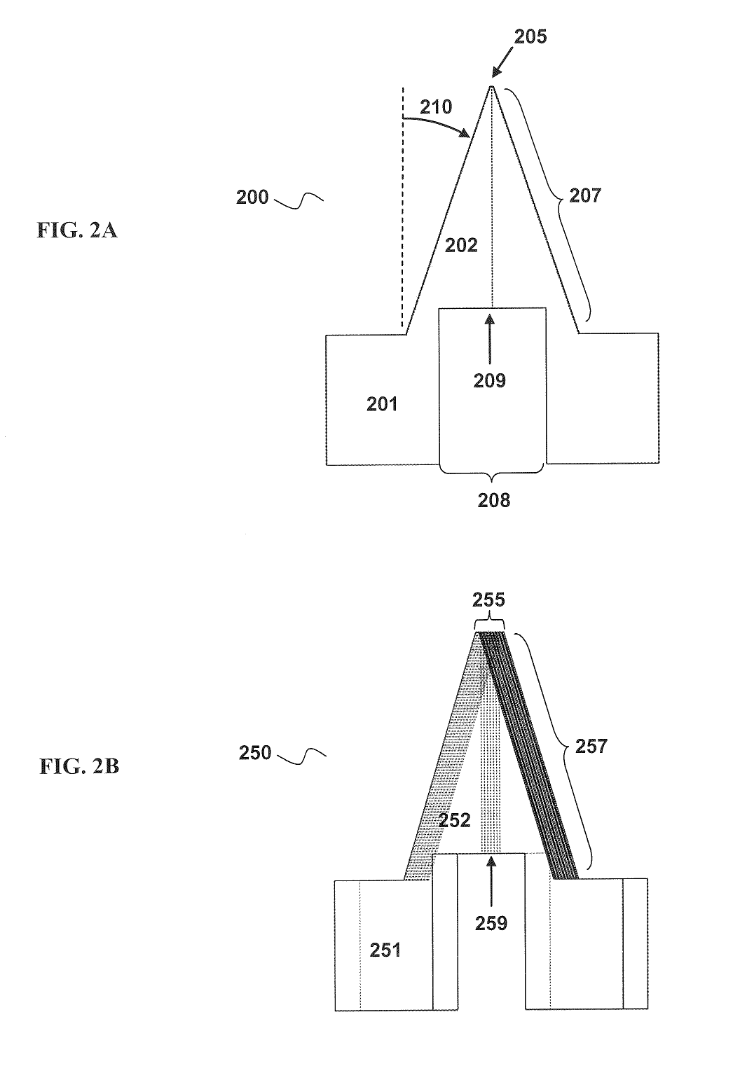

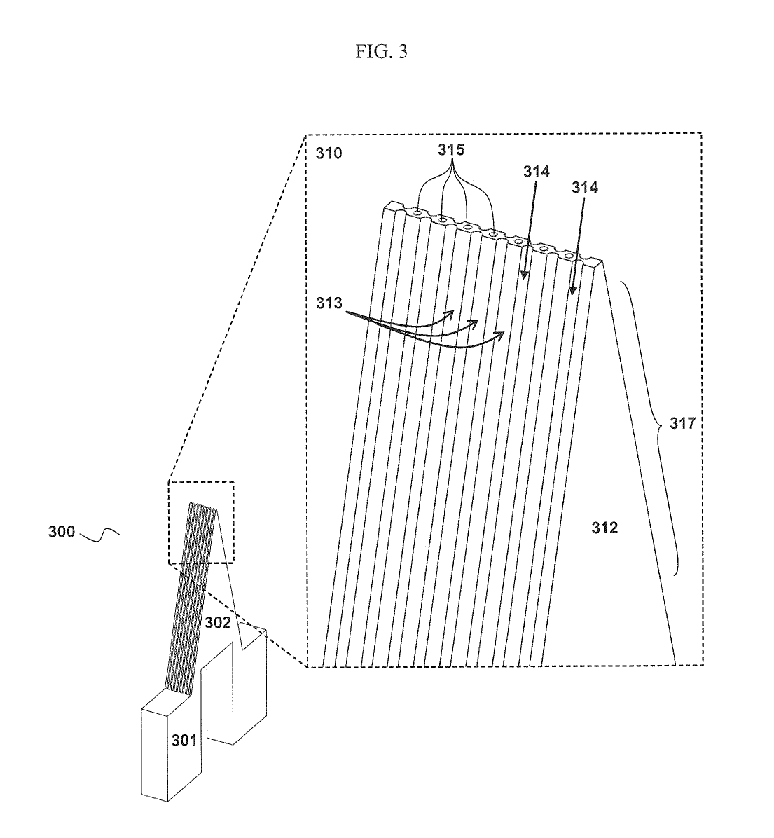

FIGS. 2A and 2B provide a cross-sectional schematic representations of an extruder die of the present invention. Referring to FIG. 2A, an extruder die, 200, comprises a base, 201, having a cavity therein, 208, and a tip portion, 202, having a plurality of holes there through, 209, the holes ending in a plurality of openings, 205. The tip portion, 202, includes angular side-walls, 207, that form an angle, 210 with the base. The sidewall angle can be varied, with a sidewall angle of about 20° to about 40° being preferred. In some embodiments, the extruder die is a monolithic structure.

Referring to FIG. 2B, a three-dimensional cross-sectional schematic of an extruder die, 250, is provided. In particular, the plurality of holes, 259, passing through the tip portion, 252, can be seen, the hole terminating in a plurality of openings, 255. The sidewalls, 257, comprise a flat face having a plurality of grooves therein.

Generally, an extruder die is formed from a rigid material that is able to withstand significant pressure applied the backside of the extruder die during melt-blowing. In addition, materials should have a low coefficient of thermal expansion. Suitable materials include metals, ceramics, and the like, with stainless steel being preferred.

FIG. 3 provides a three-dimensional schematic representation of an extruder die of the present invention. Referring to FIG. 3, the extruder die, 300, includes a base portion, 301, and a tip portion, 302. An inset, 310, provides an enlargement of the tip portion. The sidewalls of the tip portion, 317, include a flat face, 313, having a plurality of grooves, 314, therein. While curved grooves are depicted, other shapes are also suitable, including trigonal grooves, square grooves (as well as other rectilinear shapes), half-hexagonal grooves, and the like. The depth of the grooves can be varied. The holes in the tip portion terminate in a plurality of openings in the, 315. The size of the holes and the openings in the tip portion of the extruder die can be varied. In some embodiments, the holes and openings have a diameter of about 0.002 in to about 0.010 in. (i.e., about 50 μm to about 250 μm). In some embodiments, the holes and openings have a diameter of 100 μm to 200 μm, 100 μm, 150 μm, or 200 μm. In some embodiments, the openings have a diameter that is less than or greater than the diameter of the holes.

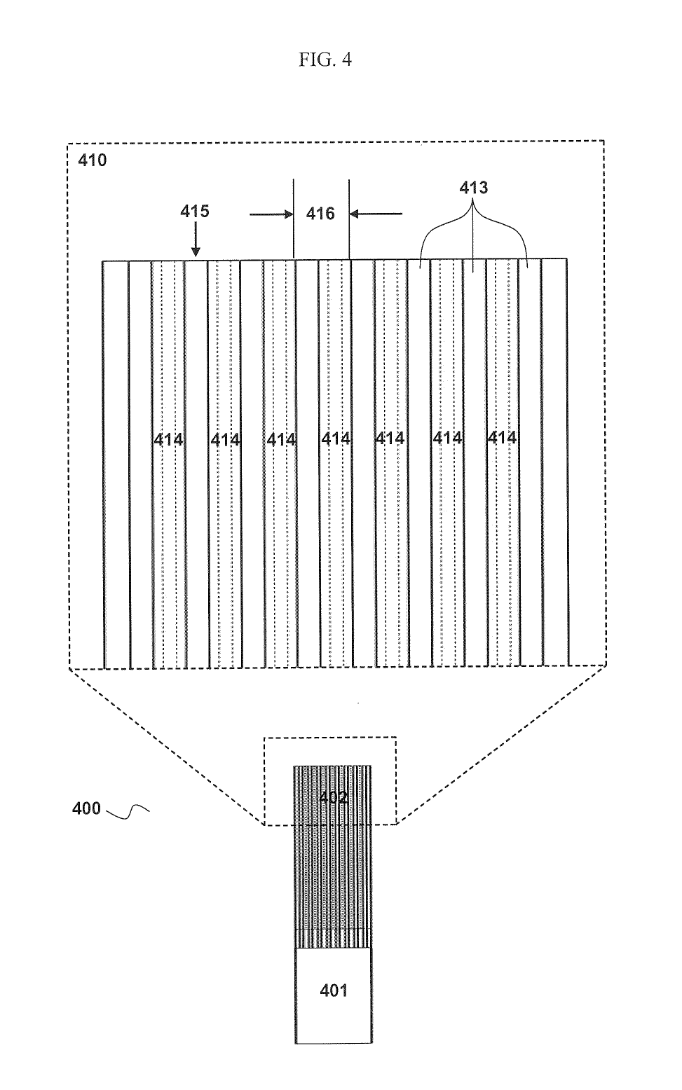

FIG. 4 provides a side-view representation of an extruder die of the present invention. Referring to FIG. 4, the extruder die, 400, comprises a base portion, 401, and a tip portion, 402. An inset, 410, provides an enlargement of the tip portion. The sidewalls of the tip portion include a flat face, 413, having a plurality of grooves, 414, therein. The holes in the tip portion terminate in a plurality of openings in the, 415. The spacing of the holes is typically periodic, with a pitch of 200 μm to 500 μm, 300 μm to 400 μm, about 300 μm, or about 350 μm. Patterns of holes or irregularly spaced holes can also be utilized depending on the application.

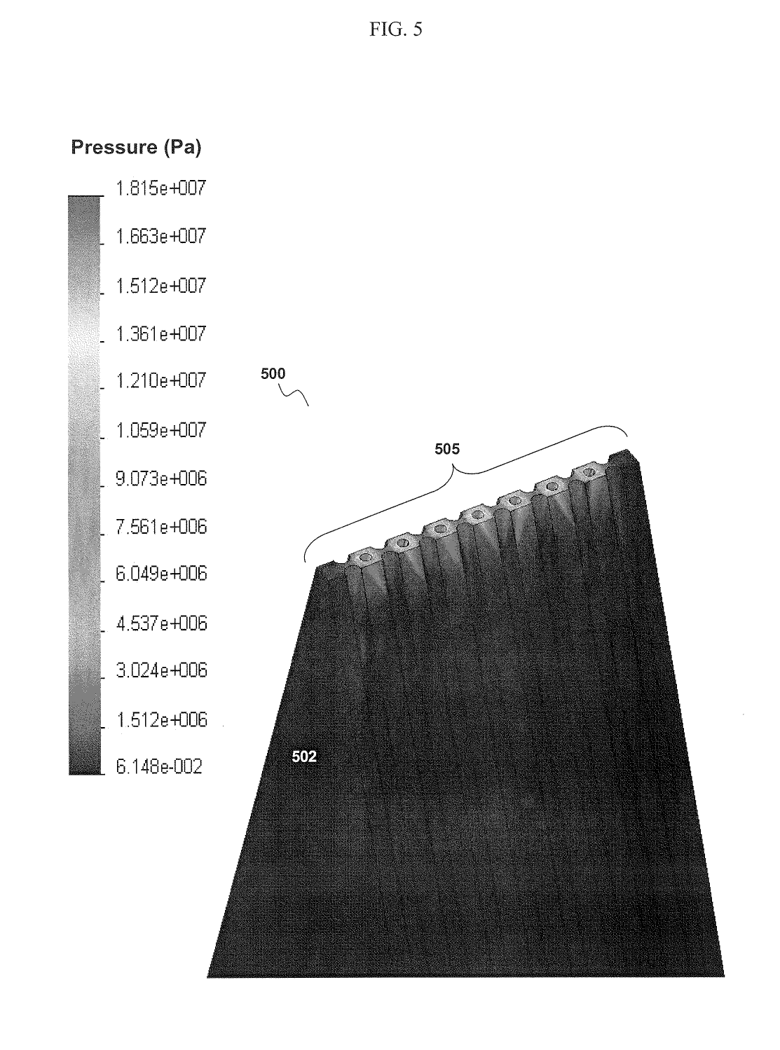

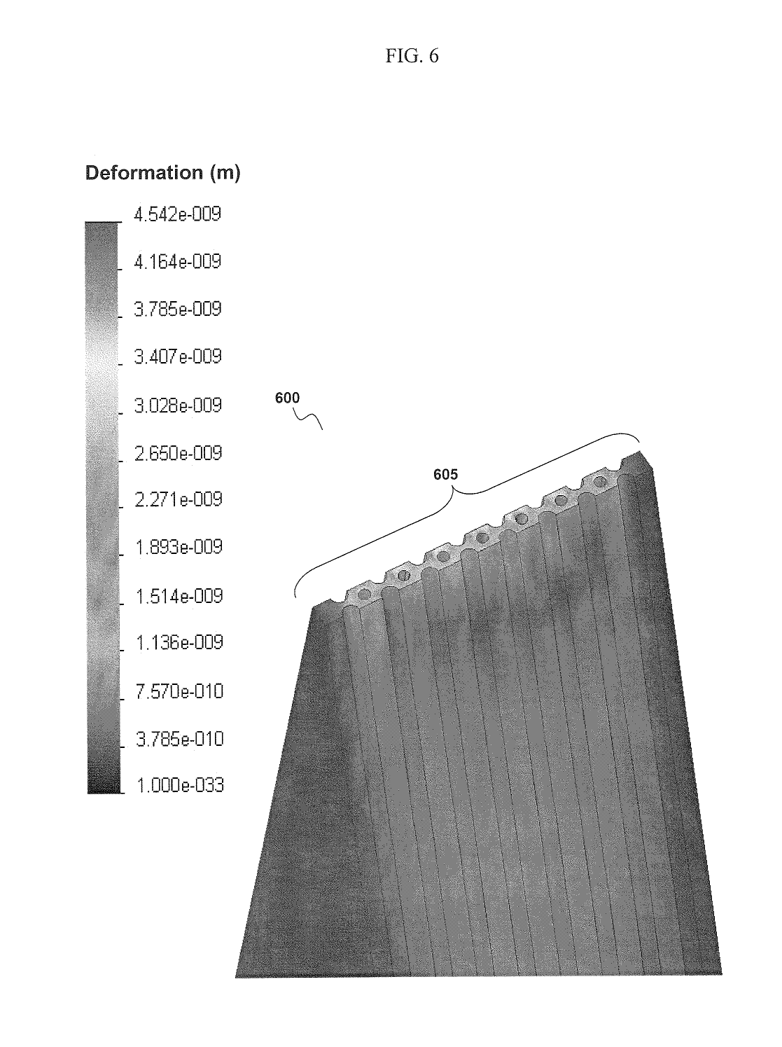

The stress distribution and extent of deformation on an extruder die having a pressure of 1,000 psi applied to the cavity was modeled using finite element analysis (performed using SOLIDWORKS® v. 2008 having add-on COSMOSWORK® 2008, Dassault Systemes SolidWorks Corp., Concord, Mass.). The results are depicted graphically in FIGS. 5 and 6, respectively. Referring to FIG. 5, an extruder die, 500, comprised of a monolithic stainless steel member, 502, having a yield strength of 1.724×10⁸ Pa, was used for the modeling. The overall shape of the extruder die was as provided in FIGS. 2A, 2B, 3 and 4. Other parameters were a hole diameter and opening diameter of 150 μm, a groove diameter of 200 μm, and a groove depth of 100 μm. The analysis shows that application of a pressure of 1,000 Pa to the cavity of the extruder die results in a maximum pressure of about 1.8×10⁷ Pa at the openings, 507, in the tip of the extruder die. Thus, the maximum stress experienced by the extruder die under operating conditions is about 10% of the yield strength when stainless steel is used as a material.

Referring to FIG. 6, a deformation analysis was also performed using the same parameters as used in the stress analysis provided in FIG. 5. The results of the deformation analysis (FIG. 6) indicate a maximum deformation of 4.5 nm at the openings in the tip portion, 607, when a pressure of 1,000 psi is applied to the cavity. Thus, a maximum deformation of about 1 part in 30,000 can be expected during operation of the extruder die.

In some embodiments, polyolefin fibers in a battery separator of the present invention have a mean diameter of 100 nm to 20 μm, 200 nm to 15 μm, 400 nm to 12 μm, 500 nm to 10 μm, 800 nm to 5 μm, or 1 μm to 4 μm.

In some embodiments, a battery separator comprises outer layers having polyolefin fibers with a mean diameter of 50 nm to 1 μm, 100 nm to 800 nm, 200 nm to 600 nm, or 300 nm to 500 nm. In some embodiments, 60% or more, 70% or more, 80% or more, or 90% or more of the fibers present in an outer layer of a battery separator have a diameter of 1 μm or less. In some embodiments, a battery separator comprises an inner layer made up of polyolefin fibers with a mean diameter of 1 μm to 20 μm, 1 μm to 15 μm, 1 μm to 10 μm, 1 μm to 8 μm, 1 μm to 5 μm, 2 μm to 20 μm, 2 μm to 15 μm, 2 μm to 10 μm, 2 μm to 6 μm, or 2 μm to 4 μm.

Battery separators having outer layers comprising a plurality of nanofibers and an inner layer comprising microfibers can be prepared by melt-blowing a first layer of polyolefin fibers having an average diameter of 50 nm to 1 μm, melt-blowing a second layer of polyolefin fibers onto the first layer, wherein the polyolefin fibers of the second layer have an average diameter of 1 μm to 20 μm, and melt-blowing a third layer of polyolefin fibers onto the second layer to provide the battery separator, wherein the polyolefin fibers of the third layer have an average diameter of 50 nm to 1 μM. Adhesion between adjacent layers is achieved upon cooling of the hot melt-blown fibers.

In some embodiments, a battery separator has a porosity of 60% or greater, 75% or greater, 80% or greater, 85% or greater, 90% or greater, 95% or greater, 60% to 98%, 75% to 98%, 85% to 98%, 90% to 98%, 93% to 98%, 95% to 98%, or 90% to 95% by volume, in a compressed state (i.e., in a battery).

In some embodiments, a battery separator comprises one or more layers of non-woven, melt-blown polyolefin fibers, wherein the fibers have an mean diameter of 50 nm to 1 μm, and the layer has a median pore size of 1 μm or less, and a porosity of 75% or greater.

In some embodiments, a layer of non-woven, melt-blown polyolefin fibers has a surface area of 5 m²/g or greater, 7.5 m²/g or greater, 10 m²/g or greater, 12.5 m²/g or greater, 15 m²/g or greater, or 20 m²/g or greater. In some embodiments, a layer of non-woven, melt-blown polyolefin fibers has a surface area of 5 m²/g to 20 m²/g, 5 m²/g to 15 m²/g, 5 m²/g to 10 m²/g, 7.5 m²/g to 20 m²/g, 7.5 m²/g to 15 m²/g, or 10 m²/g to 20 m²/g.

In some embodiments, a layer of non-woven, melt-blown polyolefin fibers has a maximum pore size of 30 μm or less, 25 μm or less, 20 μm or less, 15 μm or less, 10 μm or less, 5 μm or less, 2 μm or less, or 1 μm or less.

In some embodiments, a layer of non-woven, melt-blown polyolefin fibers has a wet:dry ratio (by weight) of about 5, about 10, about 15, about 20, or about 25. In some embodiments, a layer of non-woven, melt-blown polyolefin fibers has a wet:dry ratio (by weight) of 5 to 25, 5 to 20, 5 to 15, 5 to 10, 10 to 25, 10 to 20, 15 to 25, or 20 to 25.

In some embodiments, a layer of non-woven, melt-blown polyolefin fibers has a break point of 1 MPa or more, 1.5 MPa or more, 2 MPa or more, 2.5 MPa or more, or 3 MPa or more. In some embodiments, a layer of non-woven, melt-blown polyolefin fibers has a break point of 1 MPa to 4 MPa, 1 MPa to 3 MPa, or 2 MPa to 4 MPa.

The thickness and the basis weight of a layer of non-woven, melt-blown polyolefin fibers can vary depending on the requirements of the application (e.g., battery design, etc.). The thickness can vary, for example, from about 5 mils to about 200 mils, and the fabric weight (or basis weight) can be 10 g/m² to 800 g/m². In some embodiments, a battery separator comprises a multilayer configuration of non-woven melt-blown polyolefin fibers, the battery separator comprising outer layers of fibers having a fabric weight of 10 g/m² to 100 g/m² and an inner layer of fibers having a fabric weight of 100 g/m² to 500 g/m². In some embodiments, an outer layer of non-woven polyolefin fibers has a fabric weight of 10 g/m² to 75 g/m², 10 g/m² to 50 g/m², 10 g/m² to 25 g/m², 25 g/m² to 100 g/m², 25 g/m² to 75 g/m², or 50 g/m² to 100 g/m². In some embodiments, an inner layer of non-woven polyolefin fibers has a fabric weight of 100 g/m² to 400 g/m², 100 g/m² to 300 g/m², 200 g/m² to 500 g/m², or 300 g/m² to 500 g/m².

Not being bound by any particular theory, process parameters that can affect the degree of porosity, fabric weight, surface area, and/or fiber morphology include the air temperature at the die, the difference between the air temperature at the extruder die and the ambient air temperature (i.e., the air temperature at the collector), the die-to-collector distance, the utilization rate, and the collector speed. On one hand, a large difference in air temperature between the extruder die and the collector results in rapid cooling of the fibers, which provides finer crystalline domains in the fibers and lower mechanical strength in a layer of fibers. On the other hand, if the difference in air temperature between the extruder die and collector is too small, then the fibers can coalesce prior to cooling, resulting in larger fiber diameter and lower surface area.

In addition to a polyolefin, the layers of non-woven, melt-blown polyolefin fibers of the present invention can comprise an amphiphilic species. In some embodiments, an amphiphilic species is mixed with a polyolefin and extruded, cooled and chopped to form pellets. The pellets comprising a polyolefin and an amphiphilic species (and one or more optional additives) can be added to pure polyolefin pellets, fed to an extruder, and processed to form non-woven polyolefin fibers using a melt-blowing apparatus.

### Battery Separators

The present invention is directed to a battery separator comprising one or more layers of non-woven, melt-blown polyolefin fibers. Polyolefins suitable for preparing the battery separators of the present invention are thermoplastic polyolefins capable of being melt-blown to form fibers having a mean diameter less than 1 μm. Generally, the thermoplastic polyolefins are resistant to strong acids. Suitable polyolefins include, but are not limited to, polyethylene, polypropylene, polystyrene, polyvinyl chloride, polystyrene sulfonate, poly(styrene-co-maleic anhydride), poly(ethylene terephthalate), polyacrylic acid, poly(methyl methacrylate), and the like, and copolymers thereof. Polyethylene, polypropylene, polystyrene and polyvinylchloride are preferred for use in the lead acid battery separators of the present invention.

In some embodiments, the mean molecular weight of a polyolefin is 100,000 Da to 500,000 Da. The polyolefin can have a narrow molecular weight distribution of 50,000 Da or less, 25,000 Da or less, or 10,000 Da or less.

The battery separators are readily wetted (i.e., are wettable) by an aqueous solution, and in particular, by battery acid, at room temperature. As used herein, “wettable” refers to the ability to readily absorb water, an aqueous solution, and/or an acid that is placed on the surface of a battery separator at room temperature (i.e., about 25° C.). In some embodiments, a battery separator of the present invention is wettable such that it retains water in amount (by weight or mass) five times or more, ten times or more, twelve times or more, fifteen times or more, twenty times or more, thirty times or more, or forty times or more the mass of the battery separator.

While the polyolefin fibers are typically hydrophobic, in some embodiments the non-woven layers of fibers are rendered wettable by adding an amphiphilic species to the fibers. As used herein, an “amphiphilic species” refers to a compound (i.e., molecule, oligomer, polymer, and the like) having both hydrophilic and lipophilic functional groups. Exemplary amphiphilic species include surfactants, detergents, and the like.

In some embodiments, an amphiphilic species for use with the present invention is substantially insoluble in water at 25° C., which as used herein, refers to a water solubility of 1% or less, 0.5% or less, 0.1% or less, 0.05% or less, 0.01% or less, 0.005% or less, 0.001% or less, 0.0005% or less, or 0.0001% or less by weight (where % by weight refers to g per 100 g water at 25° C.).

In some embodiments, an amphiphilic species has a molecular weight of 10,000 Da or less, 8,000 Da or less, 6,000 Da or less, 5,000 Da or less, 4,000 Da or less, 3,000 Da or less, 2,500 Da or less, 2,000 Da or less, 1,500 Da or less, 1,000 Da or less, 750 Da or less, or 500 Da or less.

In some embodiments, an amphiphilic species is present in a fiber layer in a concentration of 0.1% to 20%, 0.2% to 15%, 0.5% to 10%, or 1% to 6%, by weight of the fibers.

In some embodiments, an amphiphilic species is present in a concentration of 0.1% to 20% by weight of the fibers, has an average molecular weight of 10,000 Da or less, and is substantially insoluble in water.

In some embodiments, an amphiphilic species comprises IRGASURF® SR 100 (CIBA® Specialty Chemicals, Corp., Tarrytown, N.Y.), IRGASURF® HL 560 (CIBA® Specialty Chemicals, Corp., Tarrytown, N.Y.), or a similar species.

In some embodiments, an amphiphilic species comprises a first component present within at least a portion of the fibers having a molecular weight of 500 Da or less, and a second component present within at least a portion of the fibers having a molecular weight of 500 Da to 5,000 Da.

In some embodiments, a first component has a structure selected from: a polyethylene or polypropylene portion of 4 to 20 units with a hydrophilic, non-ionic head group; a polyethylene or polypropylene portion of 4 to 20 units linked to a hydrophilic, ionic head group (e.g., sodium dodecyl sulfate, and the like); a polyethylene glycol portion of 1 to 10 units linked to a hydrophobic head group (e.g., TRITON® X-100, Rohm & Haas Co., Philadelphia, Pa., and the like); a block copolymer of ethylene and ethylene oxide (e.g., BRIJ® 93, Uniqema Americas LLC, Wilmington, Del., and the like); a block copolymer of a perfluoropolyethylene or perfluoropolypropylene and a polyethylene glycol (e.g., ZONYL® FSO and/or ZONYL® FSN, E.I. DuPont de Nemours & Co., Wilmington, Del., and the like); and combinations thereof.

In some embodiments, a first component is present in a concentration of 0.1% to 20%, 0.2% to 15%, 0.5% to 10%, or 1% to 6%, by weight, of a fiber.

In some embodiments, a second component is a triblock copolymer of ethylene oxide and propylene oxide (e.g., PLURONIC® P104 and/or PLURONIC® F127, BASF Corp., Mount Olive, N.J., and the like). In some embodiments, a second component is distributed substantially homogeneously throughout the fibers.

In some embodiments, a second component is present in a concentration of 0.2% to 10%, 0.5% to 8%, or 1% to 6%, by weight of the fibers.

In some embodiments, a battery separator comprises a total additive concentration (i.e., species other than a polyolefin fiber) of 0.1% to 50%, 0.2% to 25%, 0.5% to 15%, 1% to 12%, 2% to 10%, 10% or less, or 5% or less, by weight of the battery separator. Additives in addition to an amphiphilic species that can be optionally added to the polyolefin fibers include, but are not limited to, a particulate additive, a polymeric additive, a surfactant, and the like, and combinations thereof.

Particulate additives include, but are not limited to, silica, alumina, kaolin, zirconia, titania, and the like, having a median particle size of 20 nm to 10 μm.

Polymeric additives include polymers that can improve the processability, wettability, mechanical strength, flexibility, basis weight, and the like. Polymeric additives include, but are not limited to, poly(dialkylsiloxanes) (e.g., PDMS, and the like), polyvinylpyrrolidone, polyvyinylalcohol, polyacrylic acid, polyacrylates, rubbers, nylons, and the like, and combinations thereof.

In some embodiments, a battery separator comprises a surfactant selected from the group consisting of: a triblock copolymer of ethylene oxide and propylene oxide (e.g., PLURONIC® P104 and/or PLURONIC® F127, BASF Corp., Mount Olive, N.J., and the like); a poly(perfluoropropylene glycol) carboxylate; a block copolymer of a perfluoropolyether and polyethylene glycol (e.g., ZONYL® 7950, E.I. DuPont de Nemours & Co., Wilmington, Del., and the like); a block copolymer of ethylene and acrylic acid; a polysiloxane having alkyl and ethylene oxide side groups; and combinations thereof.

In some embodiments, a surfactant is present in a concentration of 0.1% to 10%, 0.2% to 8%, or 0.5% to 6% by weight of the fibers.

As discussed above, an amphiphilic species or additional additive can be added to a polyolefin prior to melt-blowing of a non-woven polyolefin such that the resulting mat of fibers comprise a homogeneous distribution of species throughout the fibers.

Not being bound by any particular theory, an amphiphile, a surfactant, a polymer additive, and the like will slowly phase separate from a polyolefin fiber such that the additive slowly migrates to the surface of the polyolefin fibers. The phase separation process results in a layer of fibers that is readily wetted by an aqueous solution at room temperature due to the presence of the amphiphilic species, surfactant, or other additive on the surfaces of the polyolefin fibers.

Various other compositions and/or chemical treatments are useful to render the battery separators of the present invention wettable. The present invention is also directed to a battery separator comprising a layer of non-woven, melt-blown polyolefin fibers that include a conformal metal oxide layer coating the fibers.

Metal oxide suitable for coating the polyolefin fibers include, but are not limited to, silica (SiO_{y}), titania (TiₓO_{y}), alumina (Al_{y}O_{z}), zirconia (ZrₓO_{y}), boron oxide (B_{y}O_{z}), germania (GeₓO_{y}), hydrides thereof, alkoxides thereof, organo-substituted variants thereof, hydrates thereof, and the like, and combinations thereof (wherein x is 0.5 to 1, y is 1 to 2, and z is 2 to 3).

In some embodiments, a conformal metal oxide layer has a thickness of 2 nm to 500 nm, 2 nm to 400 nm, 2 nm to 300 nm, 2 nm to 250 nm, 2 nm to 200 nm, 2 nm to 150 nm, 2 nm to 100 nm, 2 nm to 75 nm, 2 nm to 50 nm, 2 nm to 25 nm, 2 nm to 20 nm, 2 nm to 15 nm, or 2 nm to 10 nm.

In some embodiments, a battery separator comprising a layer of non-woven, melt-blown polyolefin fibers that include a conformal metal oxide layer coating the fibers also includes an amphiphilic species, particulate, polymer, surfactant, or a combination thereof, as described herein.

The metal-oxide coated battery separators of the present invention can be prepared by sol-gel methods. In some embodiments, a sol-gel method for derivatizing a layer of polyolefin fibers comprises suspending a layer of polyolefin fibers in a solvent, contacting a metal oxide precursor with the suspended polyolefin fibers for a time sufficient to form a metal oxide thin film on the surface of the polyolefin fibers, and optionally curing the metal oxide thin film (e.g., thermochemical curing) to fully cross-link the thin film and remove any residual solvent.

The polyolefin fibers can be suspended in an alcoholic solution (e.g., methanol, ethanol, 2-propanol, and the like) comprising a metal oxide precursor, an acid, and water. Typical reaction times are about 1 hour to about 48 hours, about 2 hours to about 36 hours, about 4 hours to about 24 hours, or about 6 hours to about 18 hours. Heating the solution at about 30° C. to about 70° C. can speed up the reaction. Unreacted metal oxide precursor stays in the solution.

In some embodiments, the polyolefin fibers are derivatized with hydroxy groups (e.g., by exposing the fibers to UV light, ozone, oxygen plasma, a corona discharge, heat treatment, and the like) prior to suspension in a metal oxide precursor solution.

Metal oxide precursors suitable for use with the present invention include, but are not limited to, a metal alkoxide, a metal hydroxide, an alkoxy-metal hydroxide, an alkoxy-metal hydride, and combinations thereof. Metals suitable for use in the precursors include, but are not limited to, silicon, titanium, zirconium, boron, germanium, gallium, and the like, and combinations thereof.

Another method for providing wettable layers of polyolefin fibers is to chemically alter a surface of the fiber. Thus, the present invention is also directed to a battery separator comprising a layer of non-woven, melt-blown polyolefin fibers that include a hydrophilic polymer covalently attached to an outer surface of the fibers.

Hydrophilic polymers suitable for attachment to the polyolefin fibers include polycations, polyanions, zwitterions, as well as neutral hydrophilic polymers. Exemplary hydrophilic polymers include, without limitation, polyethyleneimine; a block copolymer of ethylene and acrylic acid; a block copolymer of ethylene and ethylene oxide; a triblock copolymer of ethylene oxide and propylene oxide; a poly(perfluoropropylene glycol) carboxylate; a block copolymer of a perfluoropolyether and polyethylene glycol; a copolymer of styrene and ethylene oxide; a copolymer of methacrylic acid and acrylic acid; a polysiloxane having alkyl and ethylene oxide side groups; a polyvinylamine having alkyl and ethylene oxide side groups; a polyvinylpyridine; a polyvinylsulfonate; a polyvinylphosphate; a polyvinylpyrrolidone; a polystyrenesulfonate; a polyvinylalcohol; a polyvinylacetate; and the like; and combinations thereof.

The hydrophilic polymers can be covalently attached to the polyolefin fibers using linker groups. Linker groups suitable for use with the present invention include, but are not limited to, epichlorohydrin, a silane, an alkoxysilane, a vinyl, a hydroxy, a carboxylic acid, and combinations thereof.

Alkoxysilanes suitable for use with the present invention include, but are not limited to, 3-(trimethylamino)propyl-triethoxysilane, 3-(amino)propyl-triethoxysilane, 3-(isocyano)propyl-triethoxysilane, 3-glycidoxypropyl-triethoxysilane, and the like, and combinations thereof.

Fibers are contacted with a linker group, and then contacted with a hydrophilic polymer that reacts with the linker group to become covalently attached to the derivatized fibers.

Not being bound by any particular theory, polyolefin fibers having a polycationic and/or neutral hydrophilic polymer attached thereto can prevent or reduce dendrite formation in the battery separators of the present invention.

In some embodiments, the polyolefin fibers are first treated (e.g., with UV light, ozone, oxygen plasma, a corona discharge, heat treatment, and the like, or any other suitable chemical treatment) to provide a plurality of hydroxy groups on the surfaces of the fibers. The hydroxy-derivatized fibers are then contacted with a linker group, or alternatively, directly contacted with a hydrophilic polymer capable of reacting with a hydroxy group.

The present invention is also directed to a battery separator comprising a layer of non-woven, melt-blown polyolefin fibers that include a hydrolyzable functional group, wherein the hydrolyzable functional group is: dispersed within at least a portion of the fibers, coated on at least a portion of the fibers, covalently attached to at least a portion of the fibers, or a combination thereof, and wherein the hydrolyzable functional group is selected from: an ester, an anhydride, a thioanhydride, an imide, a sultone, and combinations thereof.

In some embodiments, a hydrolyzable functional group is present as a copolymerization product of a poly-α-olefin with maleic anhydride, maleimide, thiomaleic anhydride, or a combination thereof. For example, polymerizable monomer having a hydrolyzable functional group can be included as a polymerization precursor and co-polymerized with a poly-α-olefin. In some embodiments, a polymerizable monomer having a hydrolyzable functional group is present in a concentration of 0.5% to 25% by mole, 1% to 20% by mole, 2% to 15% by mole, 3% to 12% by mole, or 4% to 10% by mole in a polyolefin fiber.

In some embodiments, a polymer comprising a hydrolyzable functional group can be further hydrolyzed and then reacted with excess molar equivalents of a second hydrolyzable functional group, wherein the second hydrolyzable functional group reacts with the first hydrolyzed functional group. For example, a co-polymerization product of maleic anhydride and polypropylene can be reacted with an acid to provide a di-acid derivatized polymer, which can be further reacted with a second hydrolyzable functional group.

Thus, a hydrolyzable functional group an also be grafted onto a polyolefin fiber. In some embodiments, a hydrolyzable functional group is grafted onto a copolymer of a poly-α-olefin and a vinyl alkylester, a copolymer of a poly-α-olefin and acrylic acid, a triblock copolymer of ethylene, ethylene oxide and acrylic acid. In some embodiments, a hydrolyzable functional group comprises a co-polymer of a poly-α-olefin with maleic anhydride, maleimide, thiomaleic anhydride, or a combination thereof.

In some embodiments, a hydrolyzable functional group has the following structure:

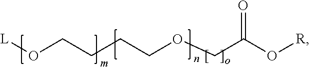

wherein m=0-10, n=0-10, o=0-30, and n+m+o=0-30, wherein R is an optionally substituted straight-chain, branched, or cyclic C₁-C₈ group, and wherein L is a point of attachment to at least one of: the fiber, a polymer dispersed within at least a portion of the fiber, a polymer coated on at least a portion of the fiber, or a combination thereof. Non-limiting examples include methyl ethanoate derivatized polyolefins, and the like.

In some embodiments, a hydrolyzable functional group has the following structure:

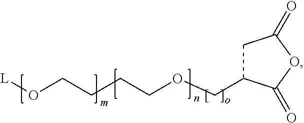

wherein n=0-10, m=0-10, o=0-30, and n+m+o=0-30, wherein [symbol] is a single or double bond, and wherein L is a point of attachment to at least one of: the fiber, a polymer dispersed within at least a portion of the fiber, a species coated on at least a portion of the fiber, or a combination thereof. Non-limiting examples include: m=0, n=0 and o=0, wherein L is a carbon atom on a polyolefin; m=1, n=0 and o=0 to 4, wherein L is a carbon atom on a polyolefin; m=0, n=1 or 2 and o=0 or 2, wherein L is a carbon atom on a polyolefin; and the like.

In some embodiments, a hydrolyzable functional group has the following structure:

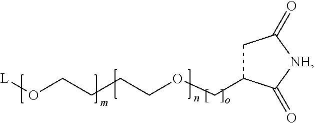

wherein n=0-10, m=0-10, o=0-30, and n+m+o=0-30, wherein [symbol] is a single or double bond, and wherein L is a point of attachment to at least one of: the fiber, a polymer dispersed within at least a portion of the fiber, a polymer coated on at least a portion of the fiber, or a combination thereof.

In some embodiments, a hydrolyzable functional group has the following structure:

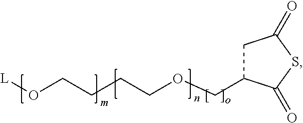

wherein n=0-10, m=0-10, o=0-30, and n+m+o=0-30, wherein [symbol] is a single or double bond, and wherein L is a point of attachment to at least one of: the fiber, a polymer dispersed within at least a portion of the fiber, a polymer coated on at least a portion of the fiber, or a combination thereof.

In some embodiments, a hydrolyzable functional group has the following structure:

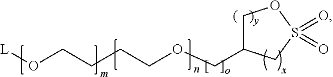

wherein n=0-10, m=0-10, o=0-30, and n+m+o=0-30, wherein x=1-3 and y=1-3, and wherein L is a point of attachment to at least one of: the fiber, a polymer dispersed within at least a portion of the fiber, a polymer coated on at least a portion of the fiber, or a combination thereof.

Hydrolyzable functional groups and other optional functional groups can be grafted onto the melt-blown polyolefin fibers by first chemically modifying the polymer using, for example, an oxygen plasma, UV exposure, a corona discharge, ozone treatment, peroxide treatment, heat treatment, and the like. The polyolefin fibers can then be derivatized by dip-coating, spray-coating, immersing, spin-coating, plasma depositing and/or chemical vapor depositing a functional group onto the chemically modified fiber surface. Other optional functional groups are described herein infra.

Another method for providing wettable layers of non-woven polyolefin fibers is to provide a mixture of polymers, wherein one of the polymers has surfactant properties. Thus, the present invention is also directed to a battery separator comprising a layer of non-woven, melt-blown polyolefin fibers that include a polymer having surfactant properties, wherein the polymer having surfactant properties is selected from: a block copolymer of ethylene and acrylic acid; a block copolymer of ethylene and ethylene oxide; a triblock copolymer of ethylene oxide and propylene oxide; a poly(perfluoropropylene glycol) carboxylate; a block copolymer of a perfluoropolyether and polyethylene glycol; a copolymer of styrene and ethylene oxide; a copolymer of methacrylic acid and acrylic acid; a polysiloxane having alkyl and ethylene oxide side groups; a polyvinylamine having alkyl and ethylene oxide side groups; a polyvinylpyridine; a polyvinylsulfonate; a polyvinylphosphate; a polyvinylpyrrolidone; a polystyrenesulfonate; a polyvinylalcohol; a polyvinylacetate; and combinations thereof.

As used herein, a “polymer having surfactant properties” refers to a polymer having both hydrophilic and hydrophobic functional groups and that has a solubility in water of at least 0.1 g/mL. A polymer having surfactant properties can have a molecular weight of 5,000 Da to 500,000 Da.

In some embodiments, at least a portion of the polymer having surfactant properties is covalently attached to an outer surface of the fiber via a linker comprising a vinyl group reacted with an acrylate group, a methacrylate group, or a combination thereof. A vinyl group, an acrylate group, a methacrylate group, or a combination thereof can be present on either of the polymer having surfactant properties and/or the fiber. In some embodiments, a polymer is pre-treated via exposure to, for example, an oxygen plasma, a corona discharge, a chemical oxidant, and the like, followed by reaction with the polymer having surfactant properties, wherein the polymer having surfactant properties comprises a plurality of reactive groups, which form a plurality of covalent bonds with the polyolefin fiber. Alternatively, a polymeric surfactant composition comprising a photoactivatable cross-linker group can be applied to a polyolefin fiber, followed by irradiation with an appropriate wavelength of light to result in covalent attachment of the polymers. A photoactivatable cross-linker group can present within the polymeric surfactant itself, the polyolefin fiber, or as an additive.

The present invention is also directed to a lead acid battery separator comprising a layer of non-woven, melt-blown polyolefin fibers wherein a fluorosurfactant is present within at least a portion of the fibers. As used herein, a “fluorosurfactant” refers to a polymer or a block copolymer that includes at least one group selected from: —CF₃, —CFH—, —CF₂—, —C₂H₃—, —C₂F₂H₂—, —C₂F₃H—, —O—CFH—, —O—CF₂—, —O—C₂H₃—, —O—C₂F₂H₂—, —O—C₂F₃H— and —O—C₂F₄—.

In some embodiments, a fluorosurfactant is selected from: a block copolymer of perfluoroethylene and polyethylene glycol, a di-block fluoropolymer having at least 50% by mass of a fluoroalkyl block and a remaining portion is an anionic or cationic hydrophilic block, and combinations thereof. In some embodiments, a fluorosurfactant has a molecular weight of 500 Da to 15,000 Da, 500 Da to 1,500 Da, 1,000 Da to 5,000 Da, 2,000 Da to 10,000 Da, or 7,500 Da to 15,000 Da.

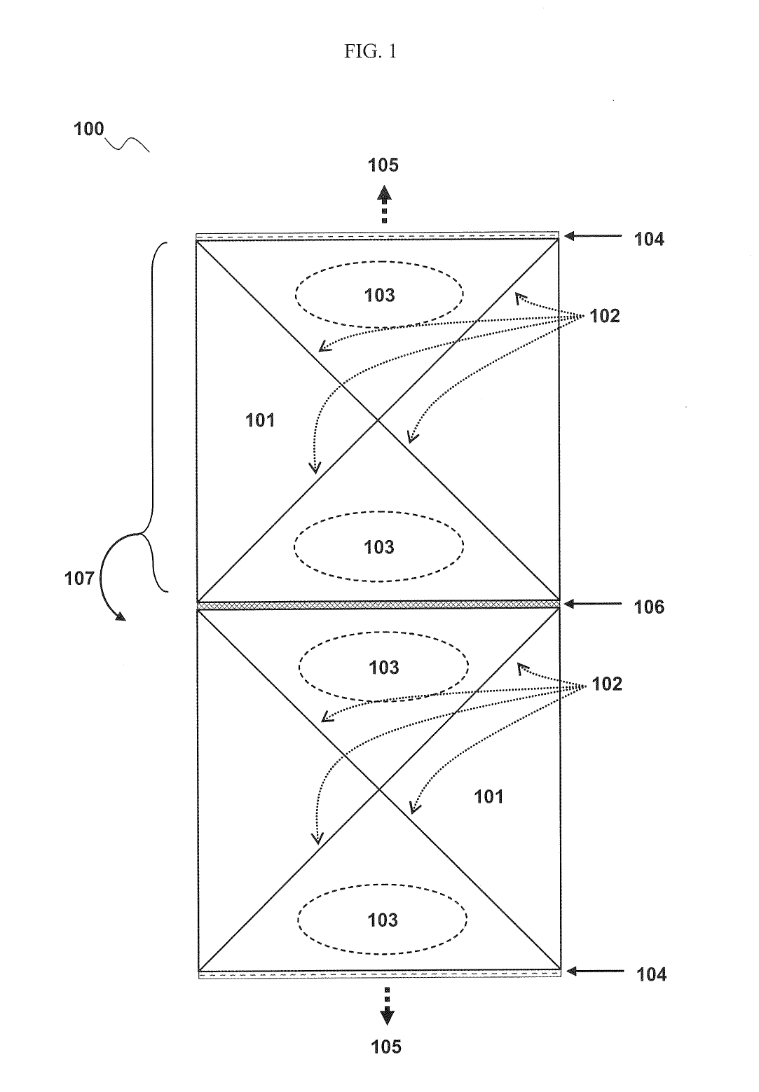

FIG. 1 provides a top- or side-view graphic representation of a battery separator, 100, of the present invention. Referring to FIG. 1, the battery separator, 100, comprises adjacent panels, 101 and 102, comprising a layer of melt-blown fibers, 103, having welds, 104, suitable for ensuring that the fibers remain bonded to one another and also for structural reinforcing the layer of fibers (providing mechanical strength). Although the weld pattern in FIG. 1 is a single “X” pattern, other weld patterns can also be used including, but not limited to, a plurality single point welds, a single weld around the perimeter of the battery separator approximately equivalent to the dimensions of a battery plate, a circular or ellipsoidal weld, and combinations thereof. A logo, 105, can optionally be embossed or otherwise applied to a surface of the separator, for example, in a space between the welds, 104. The separators are prepared with alternating perforations, 106, and welded hinges, 107, such that a battery separator can be removed as a pair of fiber layers having a welded hinge, 107, there between. The welded hinge, 107, enables adjacent layers to be rotated, 108, and positioned within a battery on opposite sides of a metal electrode (not shown). The perforations, 106, enable the battery separators to be easily separated from layers, 109 (not shown), for facile use in a manufacturing environment.

Generally, a layer of non-woven polyolefin fibers can be used in a battery separator in uncompressed form, wherein a layer thickness is not altered by, e.g., heating and/or compression. However, layers of polyolefin fibers can be further processed by stretching, heat treatment (e.g., using IR lamps, heated calender rolls, and the like), calendering, compression, and the like.

Properties of the battery separators that can be controlled include, but are not limited to, composition, stoichiometry, pore size, wettability, density, chemical stability, and the like. The melt-blown polyolefin fiber layers can be characterized using standard analytical procedures. Additional properties of the battery separators can be determined using analytical tools and methods known to persons of ordinary skill in the art.

The present invention is directed to a valve-regulated lead acid battery comprising a battery separator of the present invention. In some embodiments, a lead acid battery separator of the present invention has a lifetime of 5,000 hours or more, 10,000 hours or more, 15,000 hours or more, or 20,000 hours or more.

The battery separators of the present invention are robust and can be used in a wide variety of industrial applications without undergoing physical and/or chemical degradation. As used herein, “robust” refers to physical, dimensional and/or chemical stability. For example, the battery separators of the present invention exhibit wear resistance, dimensional stability, and chemical stability that makes them suitable for use in a wide range of environments.

In some embodiments, a valve-regulated lead acid battery comprising a battery separator described herein has a prismatic or a spiral-wound configuration.

Having generally described the invention, a further understanding can be obtained by reference to the examples provided herein. These examples are given for purposes of illustration only and are not intended to be limiting.

### EXAMPLES

### Example 1

Wettable melt-blown polyolefin layers suitable for use as separators in valve-regulated lead acid batteries were prepared as follows. Polypropylene granules were mixed with one or more surfactants and optional additives until a substantially homogeneous composition was formed (about 10-20 minutes). The resulting mixtures were added to a single screw extruder having a 3-zone heated barrel, which flowed into a heated hydraulic metering valve. The metered compositions were extruded through a 120-hole extruder die with a hole size of 0.015 in, an air gap of 0.06 in, a setback of 0.06 in, and a die angle of 30°. Other process conditions are listed in the following Table.

TABLE
Process parameters for preparing melt-blown polyolefin layers.

| Parameter | Value | |
|---|---|---|
| Extruder Zone 1 Temperature | 173° C.-194° C. | |
| Extruder Zone 2 Temperature | 198° C.-231° C. | |
| Extruder Zone 3 Temperature | 197° C.-230° C. | |
| Valve Temperature | 227° C.-240° C. | |
| Extruder Die Zone 2 Temperature | 188° C.-243° C. | |
| Extruder Die Zone 3 Temperature | 193° C.-236° C. | |
| Extruder Die Zone 4 Temperature | 198° C.-243° C. | |
| Extruder Die Pressure | <100 | psi |
| Extruder Current | 4.6 | amps |
| Throughput | 0.33 | g/hole/min |
| Air Temperature at Die | 260° | C. |
| Air Pressure | 25 | psi |

| | |
|---|---|
| Extruder Die-to-Collector Distance | 200 mm-500 mm |
| Air Temperature at Collector | 197° C.-230° C. |
| Collector Speed | 1.35 m/min-10.7 m/min |

Melt-blown fiber layers were prepared having the compositions in the following Table.

| | Polyolefin | Amphiphilic Species | Additive |
|---|---|---|---|
| Sample | (Conc.) | (appx. M.W., Conc. wt %) | (Conc. wt %) |
| Control | Polypropylene | — | — |
| | (100%) | | |
| 1 | Polypropylene | — | PE-graft MA |
| | (99%) | | (100k-500k Da, 1%) |
| 2 | Polypropylene | TRITON X-100 ® (625 Da, 3%)¹ | — |
| | (97%) | | |
| 3 | Polypropylene | PLURONIC ® P104 (5,900 Da, 5%)² | — |
| | (95%) | | |
| 4 | Polypropylene | ZONYL ® FSO (725 Da, 1%)³ | — |
| | (93%) | IRGASURF ® (6%)⁴ | |
| 5 | Polypropylene | IRGASURF ® (6%) | — |
| | (94%) | | |
| 6 | Polypropylene | TRITON X-100 ® (625 Da, 1%) | — |
| | (93%) | IRGASURF ® (6%) | |
| 7 | Polypropylene | ZONYL ® FSO (725 Da, 1%) | — |
| | (99%) | | |
| 8 | Polypropylene | ZONYL ® FSO (725 Da, 0.25%) | — |
| | (99.75%) | | |
| 9 | Polypropylene | BRIJ ® 93 (357 Da, 1.25%)⁵ | — |
| | (95%) | PE-block-PEG (575 Da, 1.87%) | |
| | | PE-block-PEG (875 Da, 1.87%) | |
| 10 | Polypropylene | BRIJ ® 93 (357 Da, 3%) | — |
| | (88%) | PE-block-PEG (575 Da, 4.5%) | |
| | | PE-block-PEG (875 Da, 4.5%) | |
| 11 | Polypropylene | PE-block-PEG (875 Da, 2.5%) | — |
| | (95.5%) | PLURONIC ® P104 (5,900 Da, 2%) | |
| 12 | Polypropylene | — | PE-graft MA |
| | (96%) | | (100k-500k Da, 4%) |
| 13 | Polypropylene | PE-block-PEG (575 Da, 1.87%) | — |
| | (91.25%) | PE-block-PEG (875 Da, 1.87%) | |
| | | PLURONIC ® P104 (5,900 Da, 5%) | |
| 14 | Polypropylene | PDMS-PEG (2%) | PDMS-PEG |
| | (98%) | | (4,000 Da, 2%) |
| 15 | Polypropylene | TRITON X-100 ® (625 Da, 2%) | PDMS-PEG |
| | (96%) | PDMS-PEG (2%) | (4,000 Da, 2%) |
| 16 | Polypropylene | PLURONIC ® F127 (12,600 Da, 2%) | — |
| | (98%) | | |
| 17 | Polypropylene | PLURONIC ® F127 (12,600 Da, 2%) | Fumed silica |
| | (96%) | | (2%) |
| 18 | Polypropylene | PLURONIC ® P104 (5,900 Da, 2%) | Fumed silica |
| | (94%) | PLURONIC ® F127 (12,600 Da, 2%) | (2%) |
| 19 | Polypropylene | PLURONIC ® P104 (5,900 Da, 2%) | — |
| | (96%) | PLURONIC ® F127 (12,600 Da, 2%) | |
| 20 | Polypropylene | BRIJ ® 93 (357 Da, 3%) | Fumed silica |
| | (86%) | PE-block-PEG (575 Da, 4.5%) | (2%) |
| | | PE-block-PEG (875 Da, 4.5%) | |
| 21 | Polypropylene | — | PP-graft-MA |
| | (50%) | | (9,100 Da, 50%) |
| 22 | Polypropylene | PLURONIC ® F127 (12,600 Da, 4.5%) | PP-graft-MA |
| | (45.5%) | | (9,100 Da, 50%) |
| 23 | Polypropylene | PLURONIC ® F127 (12,600 Da, 1.2%) | PP-graft-MA |
| | (97.6%) | | (9,100 Da, 1.2%) |
| 24 | Polypropylene | BRIJ ® 93 (357 Da, 3%) | PP-graft MA |
| | (87.6%) | PE-block-PEG (575 Da, 4.5%) | (9,100 Da, 0.4%) |
| | | PE-block-PEG (875 Da, 4.5%) | |
| Control | Polypropylene | — | — |
| | (100%) | | |

¹TRITON ® is a registered trademark of Rohm & Haas Co. (Philadelphia, PA).
²PLURONIC ® is a registered trademark of BASF Corp. (Mount Olive, NJ).
³ZONYL ® is a registered trademark of E. I. DuPont de Nemours & Co. (Wilmington, DE).
⁴IRGASURF ® is a registered trademark of CIBA ® Specialty Chemicals, Corp. (Tarrytown, NY).
⁵BRIJ ® is a registered trademark of Uniqema Americas LLC (Wilmington, DE).

### Example 2

The melt-blown fibers prepared in Example 1 were characterized. Porosity measurements were performed using a Capillary Flow Porometer Model 1100-AEX (Porous Materials, Inc., Ithaca, N.Y.). The mean fiber diameter was measured by scanning electron microscopy using a EVO 55 Environmental SEM (Carl Zeiss AG, Oberkochen, Germany) or optical microscopy using a MP3500K polarizing optical microscope (Prior Scientific, Inc., Rockland, Mass.). The water retention of the melt-blown fiber layers was also tested. The layers of fibers were placed on a Buchner funnel (about 4 in diameter), and water or acid (about 300 mL) was placed on the fiber surface. A vacuum was then applied to the Buchner funnel until about half of the water or acid had flowed into or through the layer of fibers. The mass of the fiber layers was determined before and after treatment with water or acid, and the extent of water uptake is provided in the following Table as a ratio of dry:wet mass for the layers of fibers.

TABLE
Characteristics of melt-blown layers of fibers produced in Example 1.

| | | | | Water | | |
|---|---|---|---|---|---|---|
| | Pore Size | | Mean Fiber | Retention^{d} | | |
| Sam- | (μm) | | Diam. (μm) | Dry | Wet | |
| ple | BPD^{a} | MPD^{b} | (std. dev.) | (g) | (g) | Ratio |
| Con- | tbd | tbd | 3.3 (0.7) | 0.0769 | 0.4240 | 5.5 |
| trol | | | | | | |
| 1 | tbd | tbd | 3.0 (0.6) | 0.0683 | 0.9329 | 13.7 |
| 2 | tbd | tbd | 2.3 (1.5) | 0.1128 | 0.9689 | 8.6 |
| 3 | 28.5 | 13.1 | 3.8 (0.9)^{c} | 0.0887 | 1.5448 | 17.4 |
| 4 | tbd | tbd | 2.7 (0.7)^{c} | 0.0891 | 1.2385 | 13.9 |
| 5 | 28.8 | 13.4 | 4.4 (1.1)^{c} | 0.0939 | 0.9670 | 10.3 |
| 6 | tbd | tbd | 3.9 (1.7)^{c} | 0.0903 | 1.1432 | 12.7 |
| 7 | 33.9 | 16.7 | 2.5 (0.8) | 0.0794 | 0.9044 | 11.3 |
| 8 | 29.1 | 14.4 | 2.8 (1.0) | 0.0923 | 1.1374 | 12.3 |
| 9 | 24.4 | 10.5 | 4.3 (1.8) | 0.0943 | 2.0126 | 21.6 |
| 10 | tbd | tbd | 1.9 (0.4) | 0.0886 | 1.4479 | 16.4 |
| 11 | 28.5 | 13.4 | 2.5 (0.6) | 0.0962 | 1.7177 | 18.0 |
| 12 | tbd | tbd | 2.2 (0.9) | 0.0820 | 0.6400 | 7.8 |
| 13 | tbd | tbd | 4.7 (1.2)^{c} | 0.0884 | 1.2379 | 14.0 |
| 14 | 33.4 | 15.7 | 2.9 (1.2) | 0.0837 | 1.1760 | 14.1 |
| 15 | 31.6 | 14.7 | 3.0 (0.9) | 0.0972 | 1.3380 | 13.8 |
| 16 | 32.6 | 13.3 | 2.4 (0.8) | 0.0893 | 1.1856 | 13.3 |
| 17 | tbd | tbd | 1.9 (0.7) | 0.0874 | 0.8854 | 10.2 |
| 18 | 44.7 | 16.3 | 3.7 (1.1)^{c} | tbd | tbd | tbd |
| 19 | 29.2 | 12.4 | 3.7 (0.7)^{c} | 0.0768 | 0.9637 | 12.5 |
| 20 | 38.8 | 17.2 | 2.4 (1.1) | 0.0767 | 0.7419 | 9.7 |
| 21 | 37.9 | 29.0 | 3.7 (0.6)^{c} | 0.0970 | 1.1054 | 11.4 |
| 22 | 35.4 | 14.0 | 2.0 (0.5) | 0.0711 | 0.6315 | 8.9 |
| 23 | 33.1 | 18.3 | 2.1 (0.9) | 0.0859 | 0.8330 | 9.7 |
| 24 | 39.8 | 12.7 | tbd | 0.0783 | 0.3270 | 4.2 |
| Con- | 19.7 | 8.1 | 3.0 (0.6) | 0.0737 | 0.1090 | 5.5 |
| trol | | | | | | |

^{a}Bubble point diameter, corresponding to the largest pore size.
^{b}Mean pore diameter.
^{c}As determined using optical microscopy; all other values determined via scanning electron microscopy.
^{d}Water retention value were determined using a 0.1 m² swatches of the fiber layers.

Thus, when wetted with water (or acid), the layers of fibers wick the liquid into the polyolefin mats. The above examples demonstrate wettable layers of fibers having a mean fiber diameter of about 3 μm, and have a mean pore diameter of about 15 μM (and an average bubble point diameter of about 33 μm). The mats of fibers are readily wettable and can hold more than 10 times (an average of about 12 times) of their mass in water.

### Example 3

The battery separators prepared in Example 1 (4 samples of each separator) were placed in 33% by weight concentrated sulfuric acid at 100° C. After 13 months, the battery separators were removed from the acid solution and the morphology of each sample was characterized. The results are provided in the following table.

| | Wettability | | |
|---|---|---|---|
| Sample | (Scaled 1-5)^{a} | Solution Color | Sample Condition |
| 1 | 1 | clear | intact |
| 2 | 4 | 3 samples clear; | intact |
| | | 1 sample dark brown | |
| 3 | 1 | slight discoloration | intact |
| 4 | 5 | slight discoloration | intact |
| 5 | 5 | 1 sample clear; | intact |
| | | 3 samples brown; | |
| 6 | 4 | 3 samples brown; | intact |
| | | 1 sample black | |
| 7 | 4 | brown | intact |
| 8 | 1 | 1 sample clear; | intact |
| | | 3 samples slight discoloration | |
| 9 | 4 | slight discoloration | intact |
| 10 | 5 | light brown | intact |
| 11 | 1 | dark brown | intact |
| 12 | 1 | slight discoloration | intact |
| 13 | 5 | 1 sample light brown; | intact |
| | | 3 samples dark brown | |
| 14 | 1 | 1 sample clear; | intact |
| | | 2 samples light brown; | |
| | | 1 sample dark brown | |
| 15 | 1 | light brown | intact |
| 16 | 1 | slight discoloration | intact |
| 17 | 1 | light brown | intact |
| 18 | n/a | n/a | n/a |
| 19 | 1 | slight discoloration | intact |
| 20 | 4 | 1 sample clear; | intact |
| | | 3 samples brown | |
| 21 | 1 | 2 samples clear; | intact |
| | | 2 samples slight discoloration | |
| 22 | 1 | 2 samples slight discoloration; | intact |
| | | 2 samples light brown | |
| 23 | 1 | slight discoloration | intact |
| 24 | 3 | 3 samples brown; | intact |
| | | 1 sample black | |
| Control | 1 | slight discoloration | intact |

^{a}Scaled wettability: 1 = hydrophobic, not wetted; 5 = excellent, samples completely wetted.

### Example 4

Wettable melt-blown polyolefin fiber layers suitable for use as separators in valve-regulated lead acid batteries were prepared using compositions and conditions similar to those provided in Example 1, using polypropylene homopolymer (available from Lyondell Bassell or ExxonMobil) loaded with 1% to 10% by weight of an amphiphilic species (IRGASURF® HL 560 (CIBA® Specialty Chemicals, Corp., Tarrytown, N.Y.). The metered compositions were extruded through a custom-manufactured meltblowing die similar to those disclosed in U.S. Pat. No. 6,114,017, which is incorporated herein by reference in its entirety. The resulting polyolefin fibers had an average diameter of about 300 nm to 500 nm.

### Example 5

A layered melt-blown polyolefin structure suitable for use as a battery separator was prepared by depositing a first layer of polyolefin nanofibers (about 30 g/m²) according to Example 4. A second layer (about 200 g/m²) of polyolefin microfibers was deposited onto the first layer according to the procedures of Example 1. A third layer comprising polyolefin nanofibers (about 30 g/m²) was then deposited onto the microfibers.

### Example 6

A metal oxide coating was applied to the multi-layer melt-blown polyolefin structure of Example 5. An isopropanol solution comprising a metal oxide precursor (tetraethoxysilane, 0.5% to 5% by weight), water (0.5% to 10% by weight), and an acid (concentrated sulfuric acid, concentrated acetic acid, or concentrated hydrochloric acid, 0.5% to 10% by weight) was prepared and allowed to rest for 10 minutes to 24 hours. The polyolefin fiber structure was saturated with the isopropanol solution by spraying or dip-coating (e.g., for less than 1 second to about 20 minutes). The isopropanol-saturated polyolefin fiber mat was then optionally squeezed or compressed to remove residual absorbed liquid, and then dried in a forced air oven at about 80° C. to about 120° C. for 2 to 20 minutes.

### Example 7

A hydrophilic polymer was coating was applied to a polypropylene micro-fiber structure of Example 1 (sample 5) according to the following procedure. An isopropanol solution comprising a hydrophilic polymer (polyethyleneimine, 0.5% to 20% by weight) and a cross-linker (epichlorhydrin, 0.5% to 20% by weight) was prepared. The polyolefin fiber structure was saturated with the isopropanol solution for about either by dipping or spraying. The polyolefin fiber mat was then removed from the isopropanol solution, optionally squeezed or compressed to remove residual absorbed liquid, and then dried in a forced air oven at about 80° C. to about 120° C. for 2 to 20 minutes.

### Example 8

PBT microfiber mats for use as battery separators were prepared according to procedures similar to those presented in Example 1 and 4, with the exception that the polyester was dried before fiber fabrication. Water present in the resin was removed by heating for at least 12 hours at about 150° F. under vacuum, and the dried resin was stored under vacuum until immediately before use. During fiber fabrication, the resin in the hopper on the extruder was continuously purged with and covered by a blanket of dry inert gas, e.g. nitrogen or argon.

### Example 9

Battery separators of the present invention were compared with absorptive glass mat (AGM) battery separators. The results are presented in the following table:

| | BCI | | Break | | Elonga- |
|---|---|---|---|---|---|
| Sample | Thickness | | Point | | tion |
| PP μ-fiber w/IRGASURF ® | 1.4 | mm | 2.9 | MPa | 43% |
| (Example 1; Sam. 5) | | | | | |
| PP nano-μ-nano w/IRGASURF ® (6%) | 2 | mm | 2.5 | MPa | 10% |
| (Example 5) | | | | | |
| PP nanofiber w/IRGASURF ® | 2 | mm | 0.5 | MPa | 24% |
| (Example 4) | | | | | |
| PP μ-fiber with PEI coating | 2 | mm | 1 | MPa | 31% |
| (Example 7) | | | | | |
| PBT microfiber (Example 8) | 1.2 | mm | 1.1 | MPa | 15% |
| AGM 1 (control) | 2.4 | mm | 0.3 | MPa | 1.1% |
| AGM 2 (control) | 1.7 | mm | 0.2 | MPa | 1.3% |

### Example 10

The wettability of polyolefin fibers was tested and compared. The results are presented in the following table, and demonstrate that the use of an amphiphilic species with or without a metal oxide coating layer or a hydrophilic polymer can tune the wettability of the battery separators.

| | Wet:Dry Ratio, by weight | | |
|---|---|---|---|
| | (in 33% conc. H₂SO₄) | | |
| | | Silica | PEI |
| Sample | Untreated | Coated | Coated |
| PP μ-fiber (control) | no wetting | 7.4 | 6.8 |
| PP μ-fiber w/6% IRGASURF ® | 12.6 | 8 | 11.5 |
| PP nano-μ-nano (control) | no wetting | 6.8 | 8.8 |
| PP nano-μ-nano w/6% IRGASURF ® | 18 | 8.4 | 9.7 |

### Example 11

The surface area of polyolefin fiber mats prepared herein was tested by BET nitrogen adsorption. The results are presented in the following table, and demonstrate that the polyolefin fiber mats have surface areas 5 to 10 times greater than absorptive glass mats.

| | Specific Surface Area (m²/g) | | |
|---|---|---|---|
| | | Silica | PEI |
| Sample | Untreated | Coated | Coated |
| Absorptive Glass Mats | 1.3-1.8 | n/a | n/a |
| PP μ-fiber (control) | 13.7 | 5.9 | 11.2 |
| PP μ-fiber w/6% IRGASURF ® | 6.7 | 8.3 | 8.3 |
| PP nano-μ-nano (control) | 13.9 | 6.3 | 9.9 |
| PP nano-μ-nano w/6% IRGASURF ® | 14.7 | 9 | 8.5 |

### Example 12

The volume porosity of polyolefin fiber mats prepared herein was tested using the bubble point method. The results are presented in the following table.

| | Volume Porosity | | |
|---|---|---|---|
| | | Silica | PEI |
| Sample | Untreated | Coated | Coated |
| Absorptive Glass Mats | 94% | n/a | n/a |
| PP μ-fiber (control) | 95% | 89% | 94% |
| PP μ-fiber w/6% IRGASURF ® | 85% | 86% | 88% |
| PP nano-μ-nano (control) | 95% | 91% | 90% |
| PP nano-μ-nano w/6% IRGASURF ® | 95% | 88% | 91% |

### Example 13

The maximum pore size of polyolefin fiber mats prepared herein was tested using the bubble point method. The results are presented in the following table.

| | Maximum Pore Size (μm) | | |
|---|---|---|---|
| | | Silica | PEI |
| Sample | Untreated | Coated | Coated |
| Absorptive Glass Mats | 20 | n/a | n/a |
| PP μ-fiber (control) | 29 | 23 | 20 |
| PP μ-fiber w/6% IRGASURF ® | 39 | 33 | 33 |
| PP nano-μ-nano (control) | 7 | 7 | 8 |
| PP nano-μ-nano w/6% IRGASURF ® | 8 | 7 | 8 |

### Example 14

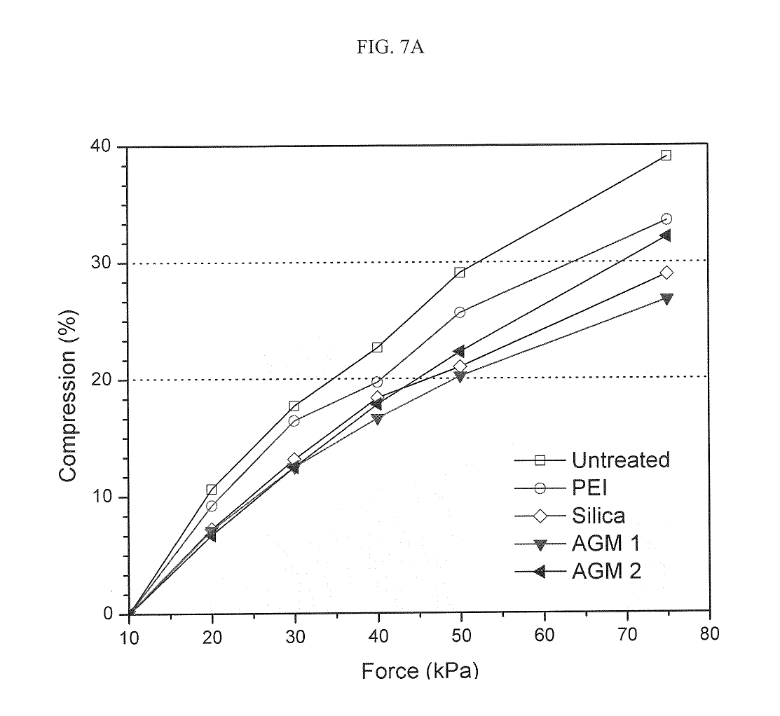

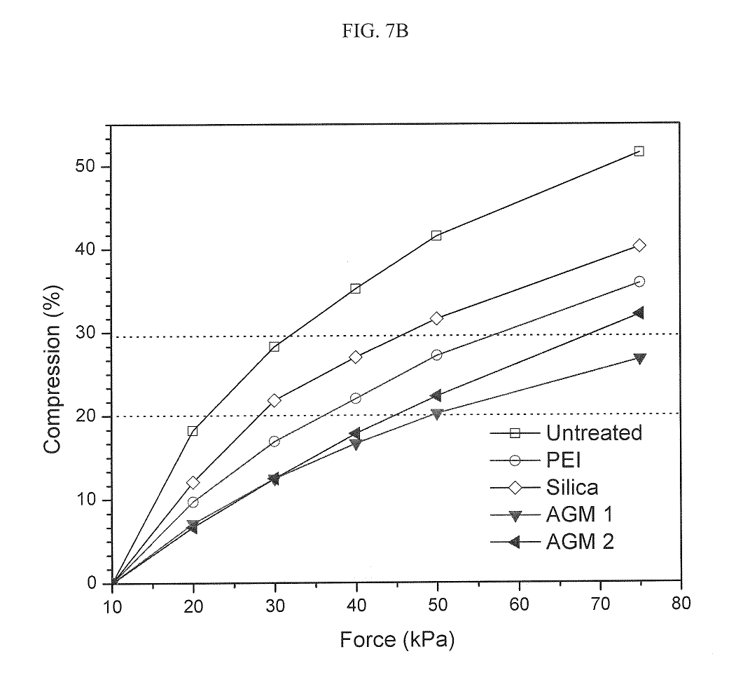

The compressibility of the polyolefin fiber mats prepared herein was tested. Microfiber polypropylene mats (as in Example 1) and Nano-micro-nano fiber layered mats (as in Example 5) were prepared and optionally coated with a metal oxide layer (silica) as in Example 6, or covalently derivatized with a hydrophilic polymer (polyethyleneimine) as in Example 7. The compressibility of the mats results are presented in FIGS. 7A-7B. Referring to FIGS. 7A-7B, the nano-micro-nano fiber layered mats are more compressible than the microfiber mats, and the metal oxide and hydrophilic polymer coatings reduce the compressibility of both classes of mats. However, all of the polyolefin fiber mats are as compressible or more compressible than the absorptive glass mats.

### Example 15

The battery separators were tested in single electrochemical cells. Two negative lead plates and one positive plate were mounted in a plastic case, with the positive plate aligned in the middle. A battery separator mat was wrapped around the positive plate. The plates were placed in a fixed position within the case using shims in order to maintain an internal pressure of 40 kPa. Lead electrodes were soldered to the positive plate and the two negative plates. After tightening the case, an electrolyte was added (1.245 g/mL conc. sulfuric acid solution in water) and the closed cell was placed on a formation program that resulted in the formation of Pb on the negative plates and PbO₂ on the positive plate.

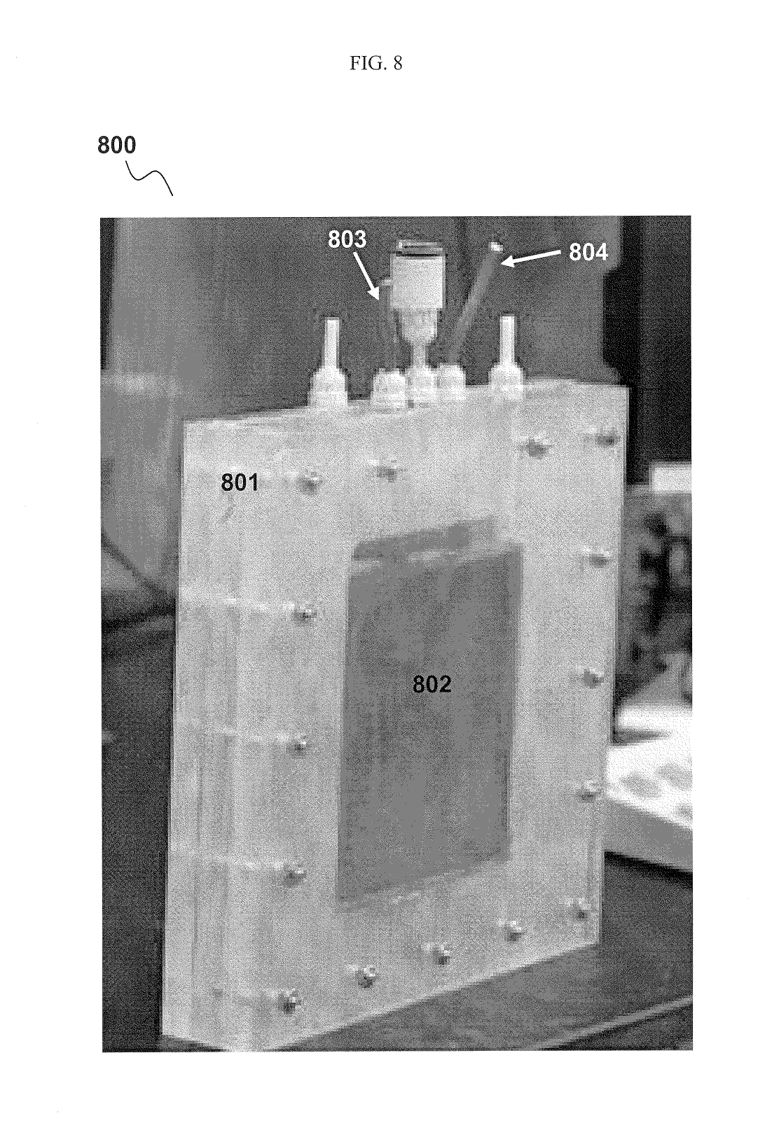

An image of an electrochemical cell is provided in FIG. 8. Referring to FIG. 8, the image, 800, shows the plastic case, 801, containing plates therein, 802. The soldered electrodes, 803 and 804, can also be seen.

A pressure valve was mounted on the plastic case and the cell was cycled using a program that discharged and charge the cell twice in order to determine its capacity. The discharge was stopped when the potential difference between the positive and negative plates dropped below 1.75 V. After discharging, the cell was recharged until the voltage was approximately 2.45 V. The capacity removed between the first and second discharges of the cell was recorded.

After the two initial cycles, the cell was programmed to discharge 80% of its capacity, followed by recharge step in which 110% of the capacity that was taken out during the discharge was returned to the cell. This cycling was continued until the voltage dropped below 1.75 V during a discharge step. Provided in the table below are exemplary results from cells that contained various separator mats, as described herein supra.

| | | Capacity | Cycles to |
|---|---|---|---|
| Separator | | (Ah) | Failure |
| Absorptive Glass Mats | Cell 1 | 16.7 | 24 |
| | Cell 2 | 17.7 | 20 |
| | Cell 3 | 19 | 27 |
| PP μ-fiber w/6% IRGASURF ® | Cell 1 | 17.7 | 51 |
| | Cell 2 | 16.2 | 49 |
| | Cell 3 | 17.4 | 44 |
| PP μ-fiber w/6% IRGASURF ® + | Cell 1 | 17.5 | 31 |
| silica coating | Cell 2 | 14.9 | 55 |
| | Cell 3 | 18.5 | 25 |
| PP μ-fiber w/6% IRGASURF ® + | Cell 1 | 13.5 | 28 |
| PEI coating | Cell 2 | 16.2 | 49 |
| | Cell 3 | 16.7 | 42 |

### Example 16

The electrochemical cells containing the various separators were also tested using a “Peukert”-test. Peukert's law holds that the capacity of a battery is dependent on the rate at which the battery is discharged:

Cₚ=I^{k}t

where Cₚ is the capacity of the electrochemical cell at a discharge rate of one ampere, I is the discharge current in amperes, k is the Peukert constant (dimensionless) and t is the time of discharge in hours. Thus, increasing the discharge rate yields lower capacity. Typical values of the Peukert constant are typically about 1.1 to about 1.3.

The electrochemical cells containing the various separators were discharged at four different rates, ranging from 1 A to 20 A. As noted above, the discharge was stopped when the voltage of the electrochemical cell dropped below 1.75 V. The Peukert constant for each of the cells containing the battery separators of the present invention was determined by the measured discharge rate and the corresponding capacity. Results are provided in the below table.

| Separator | Peukert Constant |
|---|---|
| Absorptive Glass Mat | 1.15 |
| PP μ-fiber w/6% IRGASURF ® | 1.22 |
| PP μ-fiber w/6% IRGASURF ® + silica coating | 1.17 |

### CONCLUSION

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A battery separator comprising:
outer layers comprising non-woven, melt-blown polyolefin fibers having a mean diameter of 50 nm to 1 μm; and
an inner layer comprising non-woven, melt-blown polyolefin fibers having a mean diameter of 1 μm to 20 μm,
wherein the non-woven, melt-blown polyolefin fibers include an amphiphilic species in a concentration of 0.1% to 20% by weight of the fibers, and
wherein the amphiphilic species:
has an average molecular weight less than 10,000 Da,
is substantially insoluble in water, and
renders the non-woven, melt-blown polyolefin fibers wettable by an aqueous solution at room temperature.

2. The battery separator of claim 1, wherein the outer layers have a fabric weight of 10 g/m² to 100 g/m², and the inner layer has a fabric weight of 100 g/m² to 500 g/m².

3. The battery separator of claim 1, wherein the amphiphilic species comprises a first component having an average molecular weight of 500 Da or less and a second component having an average molecular weight of 500 Da to 5,000 Da.

4. The battery separator of claim 3, wherein the first component has a structure selected from: a polyethylene or polypropylene portion of 4 to 20 units with a hydrophilic, non-ionic head group; a polyethylene or polypropylene portion of 4 to 20 units linked to a hydrophilic, ionic head group; a polyethylene glycol portion of 1 to 10 units linked to a hydrophobic head group; a block copolymer of ethylene and ethylene oxide; a block copolymer of a perfluoropolyethylene or perfluoropolypropylene and a polyethylene glycol; and combinations thereof.

5. The battery separator of claim 3, wherein the second component is a triblock copolymer of ethylene oxide and propylene oxide.

6. The battery separator of claim 1, wherein the amphiphilic species comprises IRGASURF® SR 100, IRGASURF® HL 560, or a combination thereof.

7. The battery separator of claim 1, wherein the battery separator has a porosity of 60% to 98% by volume in a compressed state.

8. The battery separator of claim 1, wherein the battery separator has a surface area of 5 m²/g or greater.

9. The battery separator of claim 1, wherein the polyolefin fiber is selected from the group consisting of: polyethylene, polypropylene, polystyrene, polyvinylchloride, and combinations thereof.

10. A valve-regulated lead acid battery comprising the battery separator of claim 1, wherein the valve-regulated lead acid battery has a prismatic or a spiral-wound configuration.

11. A battery separator comprising a layer of non-woven, melt-blown polyolefin fibers that include a conformal metal oxide layer coating the fibers.

12. The battery separator of claim 11, wherein the metal oxide is selected from the group consisting of: silica, titania, alumina, zirconia, boron oxide, germania, and combinations thereof.

13. The battery separator of claim 11, wherein the conformal metal oxide layer has a thickness of 2 nm to 500 nm.

14. The battery separator of claim 11, comprising:
outer layers of the non-woven, melt-blown polyolefin fibers having a mean diameter of 50 nm to 1 μm; and
an inner layer comprising non-woven, melt-blown polyolefin fibers having a mean diameter of 1 μm to 20 μm.

15. The battery separator of claim 14, wherein the outer layers have a fabric weight of 10 g/m² to 100 g/m², and the inner layer has a fabric weight of 100 g/m² to 500 g/m².

16. The battery separator of claim 11, wherein the non-woven, melt-blown polyolefin fibers include an amphiphilic species in a concentration of 0.1% to 20% by weight, and
wherein the amphiphilic species:
has an average molecular weight less than 10,000 Da,
is substantially insoluble in water, and
renders the non-woven, melt-blown polyolefin fibers wettable by an aqueous solution at room temperature.

17. The battery separator of claim 16, wherein the amphiphilic species comprises a first component having an average molecular weight of 500 Da or less and a second component having an average molecular weight of 500 Da to 5,000 Da.

18. The battery separator of claim 11, wherein the battery separator has a porosity of 60% to 98% by volume in a compressed state.

19. The battery separator of claim 11, wherein the battery separator has a surface area of 5 m²/g or greater.

20. A valve-regulated lead acid battery comprising the battery separator of claim 11.

21. A battery separator comprising a layer of non-woven, melt-blown polyolefin fibers that include a hydrophilic polymer covalently attached to an outer surface of the fibers, wherein the hydrophilic polymer is selected from the group consisting of: polyethyleneimine, a block copolymer of ethylene and acrylic acid; a block copolymer of ethylene and ethylene oxide; a triblock copolymer of ethylene oxide and propylene oxide; a poly(perfluoropropylene glycol) carboxylate; a block copolymer of a perfluoropolyether and polyethylene glycol; a copolymer of styrene and ethylene oxide; a copolymer of methacrylic acid and acrylic acid; a polysiloxane having alkyl and ethylene oxide side groups; a polyvinylamine having alkyl and ethylene oxide side groups; a polyvinylpyridine; a polyvinylsulfonate; a polyvinylphosphate; a polyvinylpyrrolidone; a polystyrenesulfonate; a polyvinylalcohol; a polyvinylacetate; and combinations thereof.

22. The battery separator of claim 21, comprising:
outer layers of the non-woven, melt-blown polyolefin fibers having a mean diameter of 50 nm to 1 μm; and
an inner layer comprising non-woven, melt-blown polyolefin fibers having a mean diameter of 1 μm to 20 μm.

23. The battery separator of claim 22, wherein the outer layers have a fabric weight of 10 g/m² to 100 g/m², and the inner layer has a fabric weight of 100 g/m² to 500 g/m².

24. The battery separator of claim 21, wherein the non-woven, melt-blown polyolefin fibers include an amphiphilic species in a concentration of 0.1% to 20% by weight, and
wherein the amphiphilic species:
has an average molecular weight less than 10,000 Da,
is substantially insoluble in water, and
renders the non-woven, melt-blown polyolefin fibers wettable by an aqueous solution at room temperature.

25. The battery separator of claim 24, wherein the amphiphilic species comprises a first component having an average molecular weight of 500 Da or less and a second component having an average molecular weight of 500 Da to 5,000 Da.

26. The battery separator of claim 25, wherein the battery separator has a porosity of 60% to 98% by volume in a compressed state.

27. The battery separator of claim 21, wherein the battery separator has a surface area of 5 m²/g or greater.

28. A valve-regulated lead acid battery comprising the battery separator of claim 21.

29. A method of making a battery separator, the method comprising:
melt-blowing a first layer of polyolefin fibers having an average diameter of 50 nm to 1 μm;
melt-blowing a second layer of polyolefin fibers onto the first layer, wherein the polyolefin fibers of the second layer have an average diameter of 1 μm to 20 μm; and
melt-blowing a third layer of polyolefin fibers onto the second layer to provide the battery separator, wherein the polyolefin fibers of the third layer have an average diameter of 50 nm to 1 μm
wherein the melt-blown polyolefin fibers in the first, second, and third layers include an amphiphilic species, and
wherein the amphiphilic species:
has an average molecular weight less than 10,000 Da,
is substantially insoluble in water, and
renders the non-woven, melt-blown polyolefin fibers wettable by an aqueous solution at room temperature.

30. The method of claim 29, comprising coating the battery separator with a conformal metal oxide layer.

31. The method of claim 30, wherein said coating comprises contacting the battery separator with a solution comprising: an acid and a metal oxide precursor selected from the group consisting of: a metal alkoxide, a metal hydroxide, an alkoxy-metal hydroxide, an alkoxy-metal hydride, and combinations thereof.

32. The method of claim 29, comprising:
functionalizing the polyolefin fibers with a linker group, and
covalently attaching a hydrophilic polymer to a surface of the polyolefin fibers through the linker group.

33. The method of claim 32, wherein the linker group is selected from the group consisting of: epichlorohydrin, a silane, a vinyl, a hydroxy, a carboxylic acid, and combinations thereof.

34. The method of claim 32, wherein the hydrophilic polymer is selected from the group consisting of: polyethyleneimine, a block copolymer of ethylene and acrylic acid; a block copolymer of ethylene and ethylene oxide; a triblock copolymer of ethylene oxide and propylene oxide; a poly(perfluoropropylene glycol) carboxylate; a block copolymer of a perfluoropolyether and polyethylene glycol; a copolymer of styrene and ethylene oxide; a copolymer of methacrylic acid and acrylic acid; a polysiloxane having alkyl and ethylene oxide side groups; a polyvinylamine having alkyl and ethylene oxide side groups; a polyvinylpyridine; a polyvinylsulfonate; a polyvinylphosphate; a polyvinylpyrrolidone; a polystyrenesulfonate; a polyvinylalcohol; a polyvinylacetate; and combinations thereof.

35. An extruder die comprising a base portion having a cavity therein, and a tip portion having a plurality of holes there through, the holes fluidly connecting the cavity with a plurality of openings in the tip, wherein the holes and openings have a diameter of 250 μm or less.
